(19) United States
(12) Patent Application Publication
(10) Pub. No.: US 2018/0037501 A1
(43) Pub. Date: Feb. 8, 2018

(54) MODIFICATION OF PROPERTIES OF POZZOLANIC MATERIALS THROUGH BLENDING

(71) Applicant: ROMAN CEMENT, LLC, Salt Lake City, UT (US)

(72) Inventors: John M. Guynn, Salt Lake City, UT (US); Andrew S. Hansen, Bountiful, UT (US)

(73) Assignee: Roman Cement, LLC, Salt Lake City, UT (US)

(21) Appl. No.: 15/550,722

(22) PCT Filed: Jun. 29, 2015
(86) PCT No.: PCT/US2015/038350

§ 371 Date: Aug. 11, 2017

(51) Int. Cl. C04B 18/08; C04B 28/04; C04B 40/00; C04B 18/14

(52) U.S. Cl. CPC C04B 18/08; C04B 18/141; C04B 28/04; C04B 40/0042; C04B 40/0032

(57) ABSTRACT

Methods for producing a blended pozzolan having one or more characteristics, such as one or more chemical and/or physical characteristic, in an established amount or range from two or more different pozzolans. Two or more pozzolans having different chemical and/or physical characteristics can be blended together and a chemical analyzer used to determine a chemical and/or physical characteristic of the blended pozzolan. Upon determining that the chemical and/or physical characteristic of the blended pozzolan is outside the established amount or range, modifying a blending ratio of the two or more pozzolans to restore the chemical and/or physical characteristic to the established amount or range.

### BACKGROUND OF THE INVENTION

### 1. Field of the Invention

The invention is generally in the field of pozzolans used to supplement hydraulic cements to manufacture concrete.

### 2. Relevant Technology

In modern concrete, pozzolans such as coal ash, biomass ash, volcanic ash, pumice, natural pozzolan, metallurgical slags, metakaolin, calcined clay, and silica fume are often used to replace a portion of Portland cement. Replacing a portion of Portland cement with a pozzolan yields improved concrete with higher durability, lower chloride permeability, reduced creep, increased resistance to chemical attack, lower cost, and reduced environmental impact. Pozzolans include amorphous silica that can react with excess calcium hydroxide released during hydration of Portland cement. However, there is a limit to how much Portland cement can be replaced with pozzolan because they are slower reacting and generally retard strength development.

### BRIEF SUMMARY

Disclosed herein are methods for manufacturing a blended pozzolan from two or more different pozzolans that have different chemical and/or physical characteristics. Also disclosed are blended pozzolans made according to the disclosed methods and pozzolan cements made using the blended pozzolans and a hydraulic cement.

In some embodiments, a method for manufacturing a blended pozzolan having a characteristic in an established amount or range prior to blending with cement comprises: (1) blending two or more pozzolans that differ in a characteristic selected from the group consisting of calcium oxide content, alumina content, silica content, ratio of alumina to silica, amorphous mineral content, crystalline mineral content, iron oxide content, magnesium oxide content, alkali metal content, sulfate content, particle size distribution, specific gravity, and combinations thereof to form the blended pozzolan; (2) measuring the characteristic of the blended pozzolan and determining whether the characteristic is in the established amount or range; and (3) upon determining that the characteristic of the blended pozzolan is outside the established amount or range, modifying a blending ratio of the two or more pozzolans to restore the characteristic of the blended pozzolan to the established amount or range.

In some embodiments, the two or more pozzolans are selected from the group consisting of coal ash, fly ash, bottom ash, municipal waste ash, biomass ash, ground granulated blast furnace slag (GGBFS), steel slag, natural pozzolan, volcanic ash, diatomaceous earth, metakaolin, silica fume, calcined clay, and trass.

In some embodiments, the two or more pozzolans comprise a pozzolan rich in calcium oxide and a pozzolan deficient in calcium oxide. By way of example, the pozzolan rich in calcium oxide may comprise at least 20% calcium oxide and the pozzolan deficient in calcium oxide may comprise 10% or less calcium oxide.

In some embodiments, the two or more pozzolans comprise a pozzolan rich in silica and a pozzolan deficient in silica. By way of example, the pozzolan rich in silica may comprise at least 50% silica and the pozzolan deficient in silica may comprise 10% or less silica.

In some embodiments, the two or more pozzolans comprise class C fly ash and class F fly ash. In other embodiments, the two or more pozzolans comprise a metallurgical slag and at least one of an ash or natural pozzolan. In one example, the two or more pozzolans comprise steel slag comprising less than 10% silica and a pozzolan that contains at least 50% silica. In another example, the two or more pozzolans comprise GGBFS and at least one of fly ash or natural pozzolan.

In some embodiments, the method further comprises blending a nonpozzolanic component with the two or more pozzolans. For example, the nonpozzolanic component may comprise one or more of limestone, Portland cement (e.g., ground cement clinker), calcium oxide, calcium hydroxide, alkali metal salt, or alkali earth metal salt.

In some embodiments, the characteristic can be measured by an X-ray diffraction device, X-ray fluorescence device, or a particle size analyzer.

In some embodiments, the blended pozzolan may comprise one or more of the following: a metallurgical slag and a pozzolan having an amorphous silica content of at least 50%; and class C fly ash and a pozzolan having an amorphous silica content of at least 50%. In some embodiments, the blended pozzolan further comprises limestone.

In some embodiments, a method for making a pozzolan cement comprising obtaining the blended pozzolan as disclosed herein and combining the blended pozzolan with a ground cement clinker. In some embodiments, the pozzolan cement can be formed as a dry blend. In other embodiments, the pozzolan cement can be formed by combining the blended pozzolan, ground cement clinker, and water to form a fresh cementitious mix.

In some embodiments, a method for blending different fly ashes together to form a blended fly ash having at least one chemical or physical characteristic in an established amount or range comprises: (1) providing a first fly ash; (2) providing a second fly ash that differs from the first fly ash with respect to at least one chemical or physical characteristic; (3) blending the first fly ash with the second fly ash to produce blended fly ash; (4) measuring the at least one chemical or physical characteristic of the blended fly ash and determining whether the at least one chemical or physical characteristic is the established amount or range; and (5) upon determining that the at least one chemical or physical characteristic of the blended fly ash is outside the established amount or range, modifying a blending ratio of the first and second fly ashes to restore the at least one chemical or physical characteristic to the established amount or range. For examples, the at least one chemical or physical characteristic may comprise one or more of calcium oxide content, particle size distribution, or specific gravity.

In some embodiments, a method for maintaining the calcium oxide content of a blended pozzolan in an established amount or range prior to blending with cement comprises: (1) blending two or more pozzolans that differ in calcium oxide content to form the blended pozzolan; (2) measuring the calcium oxide content of the blended pozzolan and determining whether the calcium oxide content is in the established amount or range; and (3) upon determining that the calcium oxide content of the blended pozzolan is outside the established amount or range, modifying a blending ratio of the two or more pozzolans to restore the calcium oxide content of the blended pozzolan to the established amount or range.

These and other aspects and features of the present invention will become more fully apparent from the following description and appended claims.

### BRIEF DESCRIPTION OF THE DRAWINGS

FIG. 1 is a schematic of a system for producing a pozzolan cement;

FIG. 2 is a schematic of a system for manufacturing a cement fraction, a pozzolan fraction, and/or a pozzolan cement using an online detector and a control module; and

FIG. 3 is a graph comparing a pozzolan cement with control blends and 100% Portland cement.

### DETAILED DESCRIPTION OF THE PREFERRED EMBODIMENTS

### I. INTRODUCTION

Disclosed herein are methods for manufacturing blended pozzolans having controlled chemical and/or physical characteristics. Also disclosed are methods for making blended cement. In some embodiments, a method for producing the pozzolan fraction of blended cement includes comminuting, classifying, and/or modifying the chemistry of the pozzolan fraction to have a desired particle size distribution, desired chemical composition, and/or a desired consistency in chemical properties and/or physical properties.

Chemical properties that may be of interest include, but are not limited to, calcium oxide content, alumina content, silica content, ratio of alumina to silica, amorphous mineral content, crystalline mineral content, iron oxide content, magnesium oxide content, alkali metal content, and sulfate content. Physical properties that may be of interest include, but are not limited to, particle size distribution, specific gravity, total amorphous content, morphology, and total crystalline content.

In one embodiment, a blended pozzolan can be manufactured from an initial pozzolan material that varies over time and which is supplemented with another pozzolan material to maintain desired characteristics. The methods of the invention can be used to produce a blended pozzolan having less variability in chemical and/or physical characteristics compared to the initial pozzolan material.

The methods for producing a blended pozzolan and/or pozzolan cement can be performed using an online detector, such as an online particle size analyzer and/or an online chemical analyzer. In one embodiment, the methods may further include a control module running computer executable instructions. The control module can be configured to receive a series of readings from the online detector and control one or more components of a hydraulic cement fraction manufacturing system and/or a pozzolan fraction manufacturing system to achieve a desired distribution of hydraulic cement particles and/or pozzolan particles and/or a desired chemical characteristic. In one embodiment, the control module can run a neural net that monitors the manufacture of the hydraulic cement fraction and/or the pozzolan fraction and adjusts settings of one or more components of the cement manufacturing system and/or the pozzolan manufacturing system to achieve a desired distribution of the hydraulic cement fraction and/or the pozzolan fraction.

Except as otherwise specified, percentages are to be understood in terms of weight percent. It will be appreciated, however, that where there is a significant disparity between the density of hydraulic cement and that of at least some pozzolans, adjustments can be made so that an equivalent volume of pozzolan is added in place of a similar volume of hydraulic cement being replaced. For example, the correct weight of pozzolan replacement may be determined by multiplying the weight of cement reduction by the ratio of the pozzolan density to the cement density.

The particle size of perfectly spherical particles is measured by the diameter. While fly ash is generally spherical owing to how it is formed, Portland cement and other pozzolan particles may be non spherical. Thus, the “particle size” shall be determined according to accepted methods for determining the particle size of ground or other otherwise non spherical materials, such as Portland cement and many pozzolans. The size of particles in a sample can be measured by visual estimation or by the use of a set of sieves. Particle size can be measured individually by optical or electron microscope analysis. The particle size distribution (PSD) can also be determined or estimated by laser and/or x-ray diffraction (XRD).

In some embodiments, a method includes: (1) blending two or more pozzolans that differ in at least one chemical and/or physical characteristic to produce a blended pozzolan (or pozzolan fraction) suitable for blending with a hydraulic cement fraction; (2) measuring the at least one chemical and/or physical characteristic of the blended pozzolan; (3) determining whether the at least one chemical and/or physical characteristic is within an established range; (4) upon determining that the at least one chemical and/or physical characteristic of the blended pozzolan is outside the established range, modifying a blending ratio of the two or more pozzolans to restore the at least one chemical and/or physical characteristic of the blended pozzolan to within the established range; and (5) performing at least one of: (5a) storing the blended pozzolan for later use in making blended cement or concrete; (5b) combining the blended pozzolan with hydraulic cement to produce a dry blended cement; (5c) combining the blended pozzolan with hydraulic cement and aggregate to form a dry blended concrete; or (5d) combining the blended pozzolan with hydraulic cement, water, and aggregate to form a cementitious mixture.

In some embodiments, the two or more pozzolans are blended using a planetary mixer, milling apparatus, classifier, or other blending apparatus known in the art of blending of dry particulate components. According to some embodiments, the blended pozzolan include less than 40%, 35%, 30%, 25%, 20%, 15%, 10%, 5%, 3%, 1%, or essentially no Portland cement or Portland cement clinker.

In some embodiments, determining whether the at least one chemical and/or physical characteristic is within an established range is performed using one or more of x-ray diffraction (XRD), x-ray fluorescece (XRF), particle size analyzer, specific gravity analyzer, wet chemical process, and other analyzing methods known in the art of cement and blended cements.

In some embodiments, a blended pozzolan, dry blended cement, or dry blended concrete is stored in a silo, hopper, or other storage apparatus known in the art of cements, blended cements, and dry blended concretes. In some embodiments, the cementitious mixture is made using a concrete batch plant mixer, concrete truck with rotating bucket, portable concrete mixer, pump apparatus, or other mixing apparatus known in the art of making cementitious mixtures.

In one embodiment, determining the chemical characteristic for the blended pozzolan includes measuring the at least one chemical characteristic using a chemical analyzer to produce a series of readings for the at least one chemical characteristic. The method can further include (i) providing a control module configured to execute computer executable instructions and receive an output from the chemical analyzer; and (ii) receiving the series of readings at the control module and calculating one or more blending parameters for blending the two or more pozzolans to achieve the desired chemical characteristic.

The at least one chemical characteristic may include one or more of calcium oxide content, alumina content, silica content, ratio of aluminate to silicate, amorphous mineral content, crystalline mineral content, calcium aluminate content, tricalcium aluminate content, tricalcium silicate content, dicalcium silicate content, monocalcium silicate content, iron oxide content, tetracalcium aluminoferrite content, magnesium oxide content, alkali metal content, phosphorus oxide content, gypsum content, sulfate content, particle size distribution, specific gravity, or a combination of these.

The two or more pozzolans are preferably blended dry. Blending in the dry state allows intimate mixing before initiating chemical reactions, such as those that may occur in the presence of water, which can alter one or more chemical and/or physical characteristics over time. Dry blending and storing (i.e., blending before use in concrete) facilitates use of a chemical analyzer to produce a blended pozzolan having one or more chemical and/or physical characteristic within a predetermined or established range. This is in contrast to the industry practice of “blending in the truck”. The present invention can produce quality control for pozzolan products similar to those observed for hydraulic cement products, which allows the blended pozzolan to be blended with a Portland cement fraction and yield predictable results.

In some embodiments, first and second pozzolans are dry blended together and then dry blended with a hydraulic cement fraction. In other embodiments, the first and second pozzolans can be blended with ground hydraulic cement powder simultaneously. However, in this embodiment, blending the first and second pozzolans and hydraulic cement fraction is performed prior to mixing with water and aggregate to form concrete. If Portland cement is provided as a dry powder with a known chemical composition, the detection of changing chemical characteristics of the blended pozzolan fraction can be determined even if the blend is a ternary blend (e.g., by factoring out the known chemical characteristics of the hydraulic cement fraction).

In some embodiments, the first and second pozzolans are blended together and thereafter mixed with hydraulic cement, water, and aggregate to form a cementitious mixture.

### II. MATERIALS

A. Hydraulic Cements

“Portland cement” commonly refers to a ground particulate material that contains tricalcium silicate (“C₃S”) (“alite”), dicalcium silicate (“C₂S”) (“belite”), tricalcium aluminate (“C₃A”) and tetracalcium aluminoferrite “(C₄AF”) (“celite”) in specified quantities established by standards such as ASTM C-150 and EN 197. The term “hydraulic cement”, as used herein, shall refer to Portland cement and related hydraulically settable materials that contain one or more of the four clinker materials (i.e., C₂S, C₃S, C₃A and C₄AF), including cement compositions which have a high content of tricalcium silicate, cements that are chemically similar or analogous to ordinary Portland cement, and cements that fall within ASTM specification C-150.

In general, hydraulic cements are materials that, when mixed with water and allowed to set, are resistant to degradation by water. The cement can be a Portland cement, modified Portland cement, or masonry cement. “Portland cement”, as used in the trade, means a hydraulic cement produced by pulverizing cement clinker particles (or nodules), comprising hydraulic calcium silicates, calcium aluminates, and calcium aluminoferrites, and usually containing one or more forms of calcium sulfate as an interground addition. Portland cements are classified in ASTM C-150 as Type I, II, III, IV, and V. Other hydraulically settable materials include ground granulated blast-furnace slag, hydraulic hydrated lime, white cement, calcium aluminate cement, silicate cement, phosphate cement, high-alumina cement, magnesium oxychloride cement, oil well cements (e.g., Type VI, VII and VIII), and combinations of these and other similar materials.

Portland cement is typically manufactured by grinding cement clinker into fine powder. Various types of cement grinders are currently used to grind clinker. In a typical grinding process, the clinker is ground until a desired fineness is achieved. The cement can be classified to remove coarse particles (e.g., greater than about 45 μm in diameter), which are typically returned to the mill for further grinding. Ordinary Portland cement (OPC) is typically ground to have a desired fineness and particle size distribution between 0.1-100 μm, preferably 0.1-45 μm. The generally accepted method for determining “fineness” of OPC is the “Blaine permeability test”, which is performed by blowing or pulling air through an amount of cement powder and determining the air permeability of the cement. This gives an approximation of the total specific surface area of the cement particles, which is related to reactivity.

In one embodiment, the tricalcium silicate content of hydraulic cement may be greater than about 50%, 55%, 60%, or 65%. Hydraulic cement may advantageously include a higher concentration of tricalcium silicates as compared to OPC because excess lime released therefrom does not remain as interstitial portlandite (Ca(OH)₂), as in concrete made using 100% OPC, but can reacts with silicate ions release from amorphous silica found in pozzolans to form calcium-silicate-hydrate (“CSH”). The increased tricalcium silicate content can be used to offset the lack of calcium silicates in the pozzolan fraction of blended cement. The increase in tricalcium silicate may depend in part on the percentage of pozzolan in the blend. For example increased concentrations of tricalcium silicate in the hydraulic cement fraction can be used when percentages of pozzolan are greater than about 20%, 30%, 40%, 50%, or 60%.

B. Pozzolans

Pozzolans are usually defined as materials that contain constituents which will combine with free lime in the presence of water to form stable insoluble CSH compounds possessing cementing properties. Pozzolans can be divided into two groups: natural and artificial. Natural pozzolans are generally materials of volcanic origin, but include diatomaceous earths, metakaolin, and calcined clays. Artificial pozzolans are mainly industrial byproducts obtained by heat treatment of natural minerals found in coal, ores, and other materials subjected to high temperature processes. Artificial pozzolans can be derived from clay, shale and certain siliceous rocks, and pulverized fuel ash (e.g., fly ash). Metallurgical slags, such as ground granulated blast furnace slag and steel slag, and class C fly ash are examples of more reactive pozzolans.

Two classes of fly ash are defined by ASTM C-618: Class F and Class C. The main difference is the amount of calcium, silica, alumina, and iron content in the ash. Class F fly ash typically contains less than 10% lime (CaO); Class C fly ash generally contains more than 20% lime (CaO). The chemical properties of fly ash are largely influenced by the chemical content of the coal burned (i.e., anthracite, bituminous, or lignite).

Any geologic material, both natural and artificial, which exhibits pozzolanic activity, can be used to make blended cements. Diatomaceous earth, opaline, cherts, clays, shales, fly ash, silica fume, volcanic tuffs, pumices, and trasses are some of the known pozzolans. In order to reduce water demand and thereby improve strength while maintaining desired flow properties, pozzolans having more uniform surfaces (e.g., spherical or spheroidal) may be desirable. An example of a generally spherical pozzolan is fly ash, owning to how it is formed.

The lime (CaO) content within different pozzolans can vary from about 0% to about 50% by weight. In some embodiments, the lime content of a given pozzolan can be less than about 60, 50%, 45%, 40%, 35%, 30%, 25%, 20%, 15%, 10%, 5%, 3%, or 1%. In some embodiments, the lime content of a given pozzolan can be greater than 0%, 1%, 3%, 5%, 10%, 15%, 20%, 25%, 30%, 35%, 40%, 45%, 50%, or 60%. In some embodiments, where the lime content of a first pozzolan is greater than a specified amount or range, it may be desirable to blend the first pozzolan with a second pozzolan having a lower lime content in order to yield a blended pozzolan having a lime content in a specified amount or range. In some embodiments, the specified lime content can be any whole number percentage or fractional amount between 1.0% and 60.0% (e.g., 5%, 10%, 15%, 20%, 25%, 30%, 35%, or 40%), or any range bounded by lower and upper range endpoints consisting of any whole number percentage or fractional amount between 1.0% and 60.0% (e.g., 5%, 10%, 15%, 20%, 25%, 30%, 35%, or 40%).

The amorphous (or glassy) silica content within different pozzolans can vary from about 1% to about 99% by weight. In some embodiments, the amorphous silica content of a given pozzolan can be less than about 99%, 95%, 90%, 85%, 80%, 75%, 70%, 65%, 60%, 55%, 40%, 45%, or 40%. In some embodiments, the amorphous silica content of a given pozzolan can be greater than 1%, 3%, 5%, 10%, 15%, 20%, 25%, 30%, 35%, 40%, 45%, 50%, or 60%. In some embodiments, where the amorphous silica content of a first pozzolan is lower than a specified amount or range, it may be desirable to blend the first pozzolan with a second pozzolan having a higher amorphous silica content in order to yield a blended pozzolan having an amorphous silica content in a specified amount or range. In some embodiments, the specified amorphous silica content can be any whole number percentage or fractional amount between 10.0% and 80.0% (e.g., 15%, 20%, 25%, 30%, 35%, 40%, 45%, 50%, 55%, or 60%), or any range bounded by lower and upper range endpoints consisting of any whole number percentage or fractional amount between 10.0% and 80.0% (e.g., 15%, 20%, 25%, 30%, 35%, 40%, 45%, 50%, 55%, or 60%).

The amorphous (or glassy) alumina content within different pozzolans can vary from about 0.1% to about 40% by weight. In some embodiments, the amorphous alumina content of a given pozzolan can be less than about 40%, 35%, 30%, 25%, 20%, 15%, 10%, 5%, 3%, or 1%. In some embodiments, the amorphous alumina content of a given pozzolan can be greater than 1%, 3%, 5%, 10%, 15%, 20%, 25%, or 30%). In some embodiments, where the amorphous alumina content of a first pozzolan is lower than a specified amount or range, it may be desirable to blend the first pozzolan with a second pozzolan having a higher amorphous alumina content in order to yield a blended pozzolan having an amorphous alumina content in a specified amount or range. In some embodiments, the specified amorphous alumina content can be any whole number percentage or fractional amount between 1.0% and 30.0% (e.g., 1%, 3%, 5%, 10%, 15%, 20%, 25%, or 30%), or any range bounded by lower and upper range endpoints consisting of any whole number percentage or fractional amount between 10.0% and 80.0% (e.g., 1%, 3%, 5%, 10%, 15%, 20%, 25%, or 30%).

Pozzolans can have other mineral or chemical characteristics that are of interest when making a blended pozzolan and/or pozzolan cement. One of skill in the art can, using the illustrated examples and principles described herein, establish a specified or desired amount if one or more of such other mineral or chemical characteristics and, by modifying blending parameters and/or by adding supplemental materials, produce a blended pozzolan and/or pozzolan cement having one or more desired chemical and/or mineral characteristics that are not contained in any single pozzolan by itself.

Another characteristic that may be of interest is the particles size distribution of the pozzolan or pozzolan blend. For example, it may be desired to produce a particle size optimized pozzolan fraction for blending with hydraulic cement to make pozzolan cement (e.g., blended cement containing one or more pozzolans and one or more hydraulic cements, such as Portland cement). Examples include binary and ternary blends.

In some embodiments, it may be desirable to produce a particle size optimized binary blend in which at least a portion of the coarse cement particles are replaced by or supplemented with coarse pozzolan particles. The particle size distribution of a coarse pozzolan fraction of a binary blended pozzolan cement can be similar to that of coarser particles found in OPC (e.g., 20-45 μm). According to one embodiment, the d15, d10, d5 or d1 of the coarse pozzolan particles is at least about 5 μm, 7.5 μm, 10 μm, 15 μm, 20 μm, or 25 μm. The coarse pozzolan fraction can also have a distribution in which the d80, d85, d90, d95, or d99 is less than about 120 μm, 100 μm, 80 μm, 60 μm, or 45 μm. The use of a finer cement fraction and a coarser pozzolan fraction yields a binary blend.

In some embodiments, it may be desirable to produce a particle size optimized ternary blend in which at least a portion of the ultrafine cement particles are replaced by or supplemented with ultrafine pozzolan particles and at least a portion of the coarse cement particles are replaced by or supplemented with coarse pozzolan particles.

The fine pozzolan fraction may have a d90 less than about 10 μm, 8 μm, 6.5 μm, 5 μm, 4 μm, 3.5 μm, 3 μm, 2.5 μm, 2 μm, 1.5 μm, or 1 μm. The fine pozzolan particles may be desirable to increase particle packing density, help disperse fine cement particles, and increase fluidity. The coarse pozzolan fraction may have a d10 of at least at least about 5 μm, 7.5 μm, 10 μm, 15 μm, 20 μm, or 25 μm. The coarse pozzolan particles may be desirable to increase particle packing density, increase fluidity, increase workability, and reduce shrinkage.

In one embodiment, the fine pozzolan fraction can be a comminuted fraction obtained from classifying a pozzolan to yield an intermediate fine fraction and a coarse fraction and then comminuting the fine fraction to achieve a finer PSD. Alternatively, a pozzolan stream can be classified into three fractions: (1) an ultrafine fraction; (2) a medium fraction; and (3) a coarse fraction. The coarse fraction can be used to make binary and/or ternary blends, the ultrafine fraction can be used to make ternary blends, and the medium fraction can be used like ordinary fly ash (e.g., by blending with OPC to make conventional blended cement and concrete).

C. Supplemental Materials

Hydraulic cements such as Portland cement which contain tricalcium silicate typically provide excess lime is available for reaction with pozzolans. Depending on the relative proportion of tricalcium silicate in the hydraulic cement and the relative quantity of hydraulic cement within the pozzolan cement, it may be desirable to include supplemental lime (e.g., calcium oxide or calcium hydroxide) to provide additional calcium hydroxide for reaction with the pozzolan fraction. The amount of supplemental lime may vary from about 0-30% by weight of the overall pozzolan cement depending on the amount of pozzolan and deficit of calcium, or about 2-25%, or about 5-20%.

Other bases, such as magnesium oxide, magnesium hydroxide, alkali metal oxides, and alkali metal hydroxides can be added to accelerate the lime-pozzolan reaction. Other accelerators known in the art can be used, such sodium sulfate, calcium chloride, sodium citrate, sodium silicate, and the like.

Limestone can be added in order accelerate cement hydration and/or formation of cement hydration products. Ground limestone can be added. In some embodiments, limestone is added to a blended pozzolan and/or pozzolan cement in a range of about 1% to about 30%, or about 2% to about 20%, or about 3% to about 15%. Alternatively, calcium carbonate can be generated in situ by adding carbon dioxide to a concrete mixture, which can react with hydrated lime in the concrete mixture. The carbon dioxide can be added in a range of about 0.01% to about 5%, or about 0.05% to about 3%, or about 0.1% to about 1% by weight of the hydraulic cement.

### III. POZZOLAN CEMENT

Hydraulic cement and two or more pozzolans can be blended together to produce a pozzolan cement having a desired chemical and/or physical characteristics. In some embodiments, pozzolan cement includes at least about 30% pozzolan and less than about 70% hydraulic cement (e.g., 55-70% hydraulic cement by volume and 30-45% pozzolan by volume). In another embodiment, pozzolan cement includes at least about 40%, 45%, 50%, 55%, 60%, 65%, 70% pozzolan and less than about 60%, 55%, 50%, 45%, 40%, 35%, or 30% hydraulic cement.

The pozzolan cements typically include a distribution of particles spread across a wide range of particle sizes (e.g., over a range of about 0.1-120 μm, or about 0.1-100 μm, or about 0.1-80 μm, or about 0.1-60 μm, or about 0.1-45 μm).

In one embodiment, at least about 50%, 65%, 75%, 85%, 90%, or 95% of the combined pozzolan and cement particles larger than about 40 μm, 35 μm, 30 μm, 25 μm, 20 μm, 15 μm, 12.5 μm, or 10 μm comprise pozzolan particles and less than about 50%, 35%, 25%, 15%, 10%, or 5% comprise hydraulic cement. Similarly, at least about 50%, 60%, 70%, 75%, 85%, 90%, or 95% of the combined pozzolan and hydraulic cement particles smaller than about 40 μm, 35 μm, 30 μm, 25 μm, 20 μm, 15 μm, 12.5 μm, or 10 μm comprise hydraulic cement and less than about 50%, 40%, 30%, 25%, 15%, 10%, or 5% comprise pozzolan.

In binary blends, the pozzolan fraction may have an average particle size that exceeds the average particle size of the hydraulic (e.g., Portland) cement fraction. In general, the average particle size of the pozzolan fraction is in a range of about 1.25-50 times the average particle size of the hydraulic cement fraction, or about 1.5-30 times, or about 1.75-20 times, or about 2-15 times the average particle size of the hydraulic cement fraction.

Stated another way, the Blaine fineness of the hydraulic cement fraction may be about 1.25-50 times that of the pozzolan fraction, or about 1.5-30 times, about 1.75-20 times, or about 20-15 times the Blaine fineness of the pozzolan fraction.

For example, the Blaine fineness of the hydraulic cement fraction can be about 500 m²/kg or greater, preferably about 650 m²/kg or greater, and more preferably about 800 m²/kg or greater, and the Blaine fineness of the pozzolan fraction can be about 325 m²/kg or less, preferably about 300 m²/kg or less, more preferably about 275 m²/kg or less.

According to one embodiment, a high early strength blended cement can be made which has a Blaine fineness and particle size distribution (e.g., as described by the Rosin-Rammler-Sperling-Bennet distribution) that approximates that of OPC. In this way, the cement composition can behave similar to OPC in terms of water demand, rheology and strength development.

In one embodiment, the available tricalcium silicate content for the blended cement can fall within the range of available tricalcium silicates for a Type I, Type II, or Type III cement. The available tricalcium silicate content depends in part on the surface area of the hydraulic cement. In one embodiment, the tricalcium silicate content and/or the effective tricalcium silicate content of the blended cement can be greater than 45%, preferably greater than 50%, more preferably greater than about 57%, and most preferably greater than about 60%.

As mentioned above, the cement blends can substitute for OPC, including Type I, Type II, Type III, and Type V cements. Type I and Type II cements are commonly terms used to refer to a binder with characteristics defined by ASTM C-150. As those skilled in the art will appreciate, general purpose blended cements that can substitute for ASTM C-150 cement should have set times and other performance characteristics that fall within the ranges of ASTM C-150 in order to serve as a substitute for Type I, Type II, Type III, or Type V cement in the ready mix industry. In one embodiment, the blended cement meets the fineness and/or set time requirements of a Type I/II OPC, as defined in ASTM C-150. In one embodiment, the blended cements can have a fineness in a range from about 150 m²/kg to about 650 m²/kg, or about 280 m²/kg to about 600 m²/kg, or about 300 m²/kg to about 500 m²/kg, or about 350 m²/kg to about 450 m²/kg.

The reactivity of the hydraulic cement fraction can be selected or adjusted to counterbalance the reactivity of the pozzolan fraction (e.g., by reducing or increasing the average particle size or fineness to increase or reduce reactivity, increasing or decreasing the proportion of tricalcium silicate relative to dicalcium silicate to increase or decrease reactivity, increasing or reducing the quantity of supplemental lime, increasing or decreasing the quantity of gypsum, and the like). For example, where the pozzolan is slower reacting, it may be desirable to increase reactivity of the hydraulic cement fraction. Conversely, where the pozzolan is faster reacting, it may be desirable to decrease reactivity of the hydraulic cement fraction to maintain a desired overall reactivity. By adjusting the reactivity of the hydraulic cement fraction so as to best accommodate the reactivity of the available pozzolan, the present invention permits the manufacture of blended cements having a desired level of reactivity and early strength development while using a wide variety of different available pozzolans.

In some cases, it may be desirable to include inert fillers in order to provide a pozzolan cement having setting properties similar to OPC. According to one embodiment, the inert filler may include coarser particles (e.g., 25-250 μm). The inert filler may include inert fillers known in the art, examples of which include ground stone, rock and other geologic materials (e.g., ground granite, ground sand, ground bauxite, ground limestone, ground silica, ground alumina, and ground quartz).

While the ranges provided herein relative to the particle size distributions of pozzolan and hydraulic cement are expressed in terms of weight percent, in an alternative embodiment of the invention, these ranges can be expressed in volume percent. Converting weight percent to volume percent may require using ratios of the densities of the various materials.

### IV. MANUFACTURE CEMENT AND POZZOLANS

Any known method for obtaining hydraulic cement and pozzolan or pozzolan blend having a desired particle size distribution and/or fineness can be used. In general, particle size optimized hydraulic cement can be obtained by comminuting and classifying cement clinker so as to have a desired particle size distribution.

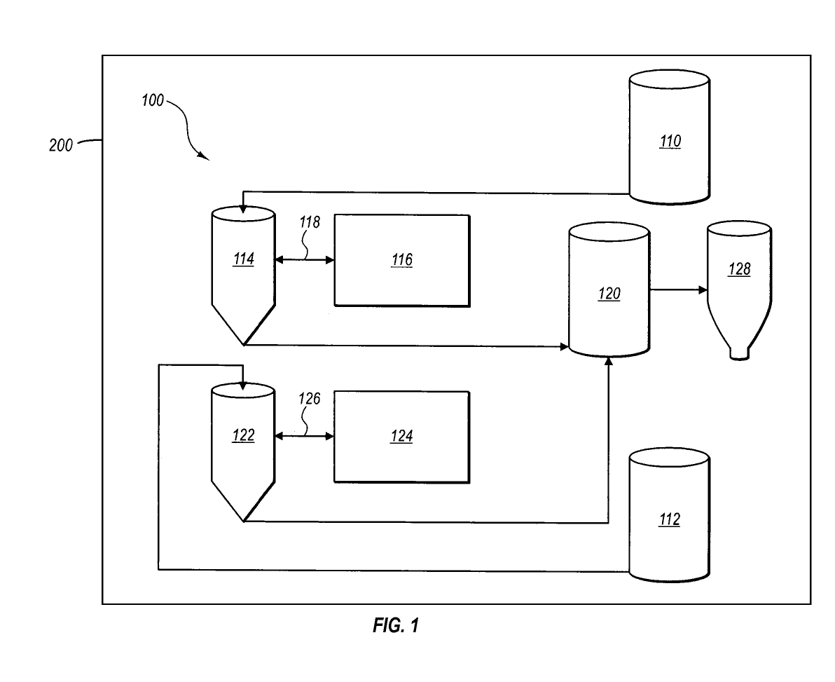

FIG. 1 illustrates a system 100 for carrying out the methods described herein. In one embodiment, an initial stream of pozzolan particles (e.g., with particle sizes distributed over a range of about 0.1-100 μm) can be stored in silo 110. An initial stream of hydraulic cement particles (e.g., Portland cement with particle sizes distributed over a range of about 0.1-45 μm) can be stored in silo 112. The initial pozzolan stream is delivered to an air classifier 114 and a top cut at a desired d90 (e.g., about 45 μm) is performed. Particles above the top cut (e.g., about 45 μm) can then be ground to yield particles smaller than the top cut in grinder 116 in a closed circuit indicated by arrows 118. Classifier 114 and/or a second classifier (not shown) can be used to dedust the pozzolan to remove at least some of the particles less than a desired d10 (e.g., about 10 μm) if the pozzolan source is finer than desired. The modified stream of pozzolan particles between the bottom cut and top cut (e.g., distributed over a range of about 10-45 μm) are then delivered to mixer 120 for mixing.

The initial stream of hydraulic cement from silo 112 is delivered to air classifier 122 and cut at a desired d90 (e.g., about 10-25 μm). The fine cement particles are delivered to mixer 120 and the coarse cement particles are delivered to grinder 124 and ground in a closed circuit as indicated by arrows 126 to achieve a particle size distribution having the desired d90 (e.g., about 11-25 μm). The ground cement particles are also delivered to mixer 120 and mixed to produce the blended pozzolan cement. The classified and ground cement particles comprise a modified stream of hydraulic cement particles. Mixer 120 can be any blending apparatus known in the art or can even be a grinder. In the case where mixer 120 is also a grinder or other comminution device, some reduction in the particle sizes of cement and pozzolan would be expected although the amount of comminuting can be selected, or even minimized, to mainly ensure intimate mixing of the cement and pozzolan particles rather than grinding. The blended cement from mixer 120 can then be delivered to one or more storage hoppers 128 for later use or distribution.

System 100 can be used to produce cement particles and pozzolan particles within any of the particle size distribution ranges described in this application. In addition, system 100 can include more or fewer comminution devices, classifiers, conduits, bag houses, analytical instrumentation, and other hardware known in the art. Hydraulic cement and pozzolan particles can be stored and moved in system 100 using any techniques known in the art, including conveyors, pneumatic systems, heavy equipment, etc. The hydraulic cement can be provided as ground cement or as clinker. As such, system 100 can be incorporated into a finish mill as understood in the cement art. In addition, system 100 can use open circuit milling in addition to or as an alternative to closed circuit milling. While system 100 shows the coarsest pozzolan particles being comminuted, those skilled in the art will recognize that pozzolan is often a waste material and the use of the removed coarse and fine pozzolan fractions is not necessary.

According to one embodiment, hydraulic cement clinker can be ground according to known methods, such as using a rod mill and/or ball mill. Such methods typically yield cement having a wide particle size distribution of about 0.1-100 μm. Thereafter, the ground cement is passed through an air classifier in order to separate the fine particle fraction. The coarse fraction can be returned to the grinder and/or introduced into a dedicated grinder in order to regrind the coarse fraction. The reground cement material is then passed through an air classifier in order to separate the fine particle fraction. The fine fraction from the second classification step can be blended with the fine fraction from the first classification step. This process can be repeated until all the cement has been ground and classified to a desired particle size distribution. Repeatedly classifying the ground cement, regrinding the coarse fraction, and blending together the fine fractions advantageously yields a fine cement material having substantially the same chemistry as the clinker from which it is made. Grinding aids and blending components (e.g., gypsum) known in the art can be added during or after the grinding process.

In an alternative embodiment, finished hydraulic cement such as OPC can be classified in order to separate the fine fraction from the coarse fraction, regrinding the coarse fraction, classifying the reground material, and blending the first and second fine fractions. This process can be repeated until all the cement has been ground and classified to the desired particle size distribution. Repeatedly classifying the ground cement, regrinding the coarse fraction, and blending together the fine fractions advantageously yields a fine cement material having substantially the same chemistry as the original hydraulic cement. Moreover, all of the cement is used. None is wasted. By way of example, the first classification step might concentrate gypsum in the fine fraction, as gypsum is often concentrated in the fine particle fraction of OPC. Regrinding the coarse fraction and blending the newly obtained fine fraction(s) with the original fine fraction can restore the original balance of gypsum to calcium silicates and aluminates.

The pozzolan fraction (e.g., fly ash, slag, or natural pozzolan), to the extent it contains an undesirable quantity of very fine and/or very coarse particles, can similarly be classified using an air classifier in order to remove at least a portion of the very fine and/or very coarse particles. Very coarse pozzolan particles (e.g., greater than about 60-120 μm) removed during classification can be ground or otherwise treated (e.g., by other fracturing methods known in the art) so as to fall within the desired particle size distribution. Very fine pozzolan particles (e.g., less than about 10 μm) removed during the classification process can be sold to end users as is or further ground into an ultra-fine product (e.g., d50 less than about 3 μm or 1 μm) so as to yield a highly reactive pozzolan material that can act as a substitute for more expensive pozzolans such as silica fume and metakaolin used to form high strength concretes.

The present invention also includes blended cements manufactured according to the methods disclosed herein and/or providing a pozzolan fraction manufactured according to the methods disclosed herein and blending it with a hydraulic cement, and/or providing a hydraulic cement manufactured according to a method disclosed herein and blending it with a pozzolan.

System 100 can be operated using a control module 200 represented schematically in FIG. 1 as a box. Control module 200 includes a computer running computer executable instructions for receiving input and sending output to one or more components in system 100. For example, control module 200 can be operable to receive and/or send input to control the operation of loading and unloading silos 110 and 112, classifiers 114 and 112, and grinders 116 and 124. Control module 200 can control a blower speed and/or drum speed in classifiers 114 and 122 and/or the extent of comminution in grinders 116 and/or 124.

### V. METHODS AND SYSTEMS THAT UTILIZE AN ONLINE DETECTOR

In one embodiment, methods and systems for making a hydraulic cement fraction and/or a pozzolan fraction of a blended cement include using at least one online detector. The online detector is configured to sample a characteristic of either or both of the fractions that can be modified to produce a blend with improved properties. In one embodiment, the online detector can be a particle size analyzer that can be used to achieve proper particle size distributions having a desired overlap and/or distribution such as those discussed above.

Many sources of pozzolan produce a stream of pozzolanic materials that vary over time. These inconsistencies can be very problematic for concrete manufactures. The present invention includes, but is not limited to, embodiments where a blended cement having a desired distribution of pozzolan and hydraulic cement and/or chemical composition is achieved using an online detector. The online detector measures the distribution and/or chemical composition of an initial hydraulic cement or pozzolan and/or a modified hydraulic cement or pozzolan to produce a series of measurements over time. A control module receives the measurements and modifies comminution and/or classification of the cement and/or pozzolan to achieve a desired product.

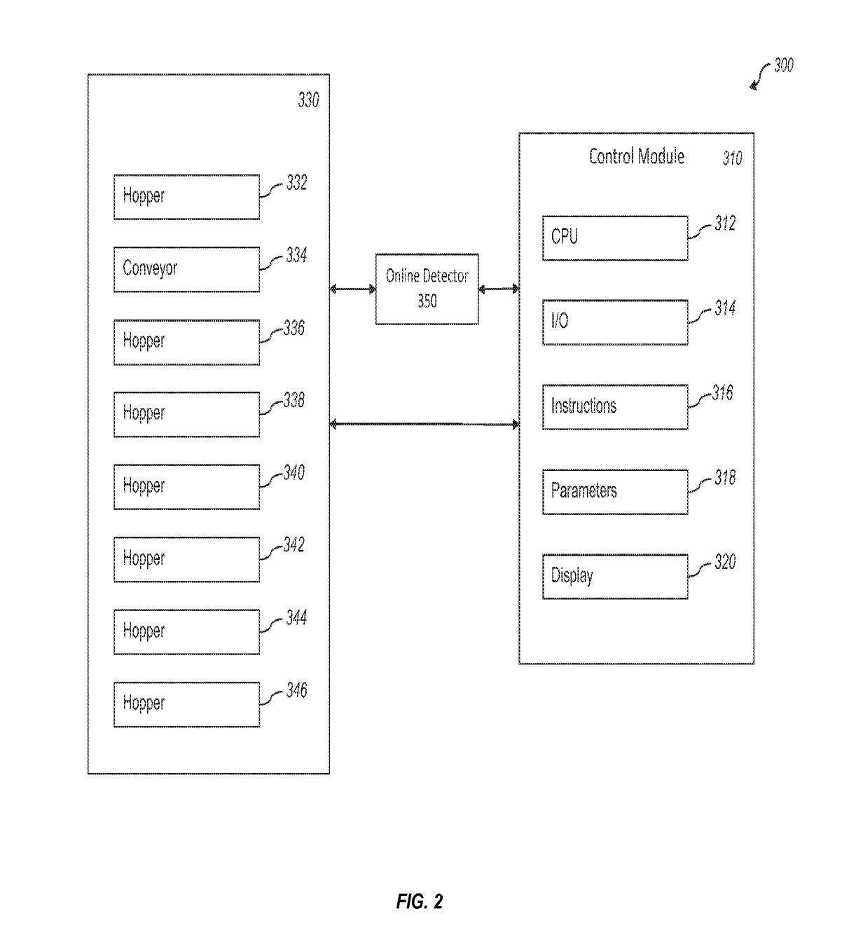

FIG. 2 is a schematic illustration of a system 300 for manufacturing cement fraction, pozzolan fraction, and/or blended cement having desired chemical composition and/or particle size distribution and/or a decreased variability over time in particle size and/or chemical composition. System 300 includes an online detector 350, a control module 310 and a sizing system 330. Control module 310 includes a central processing unit 312, an I/O interface for receiving input from online detector 350 and sizing system 330 and for outputting control output to sizing system 330 and/or online-detector 350. Control module 310 also includes computer executable instructions 316 (i.e., software) configured to operate CPU 312 and I/O 314, sizing system 330, online detector 350, and any other components of a cement or pozzolan manufacturing and/or blending facility. Instructions 316 also include instructions for performing calculations using parameters 318 and determining whether the particle size and/or chemical composition of pozzolan and/or blended cement is within a desired range. Control Module 310 may also include a display for showing the status of the system's operation, displaying queries for receiving input from an operator, and/or for provide warnings to operators in the event of a problem occurring in system 300.

Sizing system 330 can include any equipment know for use in manufacturing a pozzolan fraction of a blended cement and/or manufacturing blended cements. Examples of sizing system components include, but are not limited to, grinders, classifiers, conveyors, heaters, and fans. Sizing system 330 can be configured to process about 5-500 tons of pozzolan or blended cement per hour, preferably about 20-300 tons per hour, or 30-200 tons per hour. Sizing system can include silos and/or hoppers 332 for storing and/or loading metered quantities of feed material such as, but not limited to pozzolan, cement, chemical admixtures, and the like. Control module 310 can be coupled to hoppers for controlling the amount and timing of materials metered from hopper 332. System 330 can also include conveyors for conveying material to the various components of system 330, including pneumatic conveyors and/or belt conveyors. Control module 310 can be coupled to conveyors to control flow rates and/or direction through the conveyance system (e.g., by controlling one or more valves or metering devices). Control module 310 can also be coupled to one or more fans 336 for controlling material flow, temperatures, and/or size separation. Control module 310 can be coupled to one or more comminution devices 338 for controlling the extent of comminution, the rate of comminution, drum rotation rate, comminution temperature, and/or the rate of loading and/or unloading of comminution device 338. Control module 310 can be coupled to one or more chemical injectors for adding metered quantities of chemicals to a pozzolan fraction and/or a blended cement. Control module 342 can be coupled to a mixer for blending two or more sources of pozzolan and/or cement, controlling the timing of loading, the extent of mixing, the rate of mixing, and/or the temperature of mixing. Control module 310 can be coupled to a classifier 344 for controlling the particle size cutoff of classification, the fan speed of classifier 344 and/or drum rotation speed, loading of classifier 344 and/or any other parameters of operating classifier 344. Control module 310 can also be coupled to a bag house 346 for controlling the rate and timing of cleaning bag house 346 and/or the conveyance of materials to and from bag house 346. Those skilled in the art will recognize that there may be other equipment useful in particle sizing that can be used in system 330 and controlled by control module 310 according to the present invention. As discussed more fully below, control module 310 can be configured to calculate the proper control parameters for any of the foregoing devices using readings from online detector 350.

Online detector 350 is an analytical instrument configured to periodically receive samples of a pozzolan stream and/or cement stream and/or a blended cement and measure the particle size or chemical composition of the pozzolan stream and/or cement stream and/or blended cement. The online detector can be a particle size analyzer, an XRD analyzer, or other instrument suitable for sampling a pozzolan stream. The sample of pozzolan, cement, or blended cement can be taken from a conveyor duct or a temporary storage unit (e.g., silo) or from any component of system 330. In a preferred embodiment, the sample is taken from a stream of the pozzolan, cement, or blended cement. The sample is then analyzed to determine one or more characteristics, such as, but not limited to, the particle size distribution and/or the chemical composition. A reading of the characteristic is generated and sent to control module 310 as input thereto. In one embodiment, the sample size may be in a range from about 1 g to about 500 g, more preferably about 2 g to about 300 g, and most preferably about 5 g to about 150 g. The sampling can be carried out automatically and periodically to obtain a series of readings of one or more characteristics of the pozzolan, cement, or blended cement stream.

In one embodiment, the online detector is configured to samples the characteristic of the stream at least hourly, more preferably at least about every 5 minutes, even more preferably at least every minute, or even at least every second with at least about 20% uptime during the operation of system 330, more preferably at least 50% uptime, even more preferably at least about 75% uptime, and most preferably at least about 90% uptime of the operation of system 330. Using multiple online analyzers can allow sampling rates in these intervals and even shorter intervals.

In one embodiment, the online detector may be an online particle size analyzer. The online particle size analyzer can measure the particle size distribution using dry or wet methods. In one embodiment, the particle size analyzer measures distributions from at least about 1 micron to about 60 microns, more preferably at least about 0.2 microns to about 100 microns. An example of a suitable commercially available online particle size analyzer is the Malvern Insitec Finesess Analyzer available from Malvern Instruments (Worcestershire, UK).

In an alternative embodiment, the online analyzer may be a chemical analyzer configured to measure one or more chemical characteristics of the pozzolan stream and/or cement stream and/or blended cement stream. In one embodiment, the chemical analyzer may be an X-ray diffraction analyzer configured to measure one or more of gypsum, silicate, aluminate, calcium oxide, carbon, or iron. Methods and apparatus for performing x-ray diffraction can be found in U.S. Pat. No. 6,735,278 to Madsen, which is hereby incorporated by reference. Examples of suitable commercially available XRD analyzers include the Continuous On-Stream Mineral Analyzer from FCT-ACTech Pty Ltd, (Melbourne, Australia) and the BTX analyzer available from inXitu (Mountain View, Calif., USA).

Control module 310 receives the readings from online detector 350 and uses the readings to determine undesired variation in the pozzolan stream, cement stream and/or blended cement stream. The undesired variation can be a variation in the pozzolan, cement, or blended cement that was generated during processing of the pozzolan, cement, or blended cement in system 330 or the undesired variation may be have existed in the pozzolan or cement since its formation.

For example, particle size analyzre 350 may be positioned downstream from classifier 344 and comminution device 338. Particle size analyzre 350 periodically outputs a plurality of particle size distribution (i.e., readings) that are received by control module 310. Control module 310 is configured to receive the readings and analyze the readings according to instruction 316. Control module 310 includes one or more particle size distribution parameters. The distribution parameters establish the desired characteristic of the particle size distribution of the pozzolan fraction and/or the blended cement. The distribution parameter may be a desired volume percent of particles above and/or below a particular particle size and/or a desired volume of particles within a particular range of particle sizes as described above. The control module may compare the actual particle size readings to the distribution parameters to determine if the actual particle size distribution is within a desired range of the distribution parameter. Control module 310 also includes instructions for controlling comminution device 338, classifier 344, and/or other equipment of system 330 to modify the distribution of the pozzolan fraction and/or blended cement being produced from system 300. For example, where the d10 of the pozzolan fraction is too fine as compared to a desired distribution parameter for the d10, control module 310 may cause comminution device 338 to grind more coarsely and/or to increase the coarseness of the classification of classifier 344.

In one embodiment, control module 310 uses online detector 350 as a feedback loop to effectuate changes in the particle size distribution upstream from online detector 350. Alternatively or in addition, the measurements of online detector 350 can be used to control the blending and/or addition of chemical admixtures downstream from online detector 350 to achieve a desired particle size distribution and/or chemical composition for a pozzolan fraction and/or a blended cement fraction. The chemical characteristics and/or particle size distribution obtained from the online detector in the manufacture of a batch of pozzolan can be used to blend Portland cement and/or other pozzolans and/or admixtures to compensate for a deficiency in the chemical composition and/or particle size distribution of the material produced. For example, a finer or coarser pozzolan and/or cement may be blended with the pozzolan fraction produced from system 300 to achieve a desired pozzolan fraction and/or blend and/or lime, gypsum, hydration stabilizer, water reducer, surfactant, or other admixture can be added to the pozzolan fraction or blended cement according to the determination made by control module 310. The desired modification can be made by control module 310 using any number of mixers 342, chemical injectors 340, and/or chemical reagents.

While downstream control of blending will usually include actually controlling mixing of two or more components, in one embodiment, control module 310 can output an alphanumeric reading that is associated with the pozzolan fraction to indicate proper blending of the pozzolan fraction, cement fraction, and/or other chemical admixture to achieve a desired pozzolan fraction and/or blended cement.

Software suitable for implementing control module 310 includes, but is not limited to the Pavilion8™ software platform from Pavilion Technologies (Austin, Tex., USA), which is a division of Rockwell Automation Company (Milwaukee, Wis.). Examples of methods and systems that can be used to operate control module 310 can also be found in U.S. Pat. Nos. 5,305,230, 6,735,483, 6,493,596, 7,047,089, and 7,418,301, and U.S. publication number 2006/0259197, all of which are hereby incorporated by reference.

In some embodiments, control module 310 can obtain a particle size distribution of a cement fraction and/or an additional pozzolan fraction to be blended with the pozzolan fraction being modified in system 330. Control module 330 then uses the summed distributions to compare with a distribution parameter to determine whether the pozzolan stream is producing a desired pozzolan fraction within a desired range of the parameter.

In an alternative embodiment, system 300 can be used to produce a desired cement fraction, in which case, a cement stream is substituted for the pozzolan stream in the foregoing description of system 300. Control module 310 can control comminution and/or classifying of the cement stream to produce a cement fraction that is particle-size-optimized for blending with a pozzolan fraction. Control module can obtain a distribution of a pozzolan fraction to be blended with the cement fraction produced in system 300 and control module 310 can control comminution and/or classification of the cement fraction to have a desired distribution for blending with the particle size optimized pozzolan fraction.

The control module can be used to control manufacturing of a pozzolan fraction with particular particle size distribution characteristics important for matching the top end of a cement fraction with a bottom end of a pozzolan fraction. Control module 310 can be used to manufacture pozzolan fractions with particular distributions of particles in the d5-d45 portion of the distribution, more particularly the d10-d40 or d15-d35 (i.e., the distribution parameters (e.g., size parameters) define a desired particle size or particle size range for the volume of particles in the foregoing ranges of the distribution). In one embodiment, the particle size of the distribution parameter is in a range from about 2-35 microns, about 5-30 microns, about 7.5-25 microns, or 10-20 microns within the foregoing volume percent ranges. Where system 300 is used to produce a cement fraction, the distribution parameter can define the particle size for particles that fall within the d55-d98, d60-d95, or d70-d90. In one embodiment, the particle size of the distribution parameter is in a range from about 5-30 microns, about 7.5-25 microns, or about 10-20 microns.

In some embodiments, control module 310 may control two or more components of system 330 to simultaneously change two or more characteristics of the distribution of the pozzolan stream. For example, the d90 of the pozzolan fraction can be decreased by increasing comminution 338, and the d10 can be simultaneously be made coarser by increasing the coarseness of classification using classifier 344.

System 300 may be used to produce a cement fraction, a pozzolan fraction, and/or a blended cement having any of the characteristics described herein. System 300 may also be used alone or in combination with any of the methods disclosed herein.

### VI. CONTROLLING CHEMICAL COMPOSITION IN A BLENDED CEMENT

The present invention also includes methods that can be used alone or in combination with an online detector to control the chemical variation in a blended cement or the pozzolan fraction of a blended cement.

In this invention, the chemical composition of the pozzolan is measured over time to produce a series of measurements that reveal the chemical variation of the pozzolan. Typically, the measurement will be made using an online analyzer such as an online XRD instrument. In some embodiments, the “effective chemical content” can be approximated or measured. As discussed above, the chemical reactions that occur in the hydration of cement are most directly related to the availability of the chemical constituents (e.g., silicates, aluminates, ferrates, calcium oxide, etc) on the surface of the particles. Thus, particles that have substantially different surface areas may have the same vol % or mass % of a particular chemical constituent yet provide very different “effective chemical content.” Similarly, pozzolan and cement materials that have very different vol % or mass % of a particular constituents may perform similarly if they have a similar “effective chemical content” (also referred to herein as “effective chemical concentration”). For purposes of this invention, the term “effective chemical content” refers to a percentage of a chemical constituent in the blended cement or a fraction thereof where the percentage accounts for the surface area of the particles of that fraction. The “effective content” can be a direct measurement of the chemical constituent on the surface of the fraction (e.g., using a microscope) or may be an approximation of the effective amount using the surface area of the fraction to mathematically adjust for the difference in the availability of the chemical constituent (or similar approximation technique). The effective chemical content can be used to determine the proper blending of one or more pozzolan fractions, one or more hydraulic cement fractions, and/or one or more chemical admixtures to make a blended cement with a desired reactivity based on the surface area of chemical constituents available for reaction. By way of example, and not limitation, an effective mineral content (e.g., effective tricalcium silicate content) of a cement fraction, a pozzolan fraction, or a blended cement fraction can be calculated according to the following 3 equations, respectively: E_{c}=[(F_{c}*M_{c}), Eₚ=(Fₚ*Mₚ)], and E_{b}=[(F_{c}*M_{c}*V_{c})+(Fₚ*Mₚ*Vₚ)]. where E_{c} is the effective chemical (e.g., mineral) content in the cement fraction, Eₚ is the effective mineral content in the pozzolan fraction, E_{b} is the effective mineral content in the blended cement, F_{c} is the surface area of the cement fraction, M_{c} is the mineral content in the cement fraction, V_{c} is the volume percent of cement in the blended cement, Fₚ is the surface area of the pozzolan fraction, Mₚ is the mineral content in the pozzolan fraction, and Vₚ is the volume percent of pozzolan in the blended cement. The actual effective mineral content for the blended cement can also be calculated by dividing E_{b} by F_{b} where F_{b} is the surface area of the blended cement. The effective mineral content may be calculated for tricalcium silicates, dicalcium silicates, aluminates, gypsum, lime, carbon, and the like.

In one embodiment, a direct measurement of the effective concentration can be determined using a binding assay for the chemical constituent. The effective chemical content can be approximated by binding a chelating agent to the surface of the pozzolan or cement particles and detecting a change in the concentration of the binding agent. By way of example and not limitation, the available calcium oxide on the surface of a cement or pozzolan can be determined using a calcium chelating agent in a binding assay. The effective calcium oxide concentration can be determined placing a known quantity of cement or pozzolan into a solution of calcium chelating agent having a known concentration, allowing the calcium chelating agent to bind the cement or pozzolan, removing the cement or pozzolan particles from the solution, and detecting the change in concentration of the chelating agent in the solution. The reduction in the concentration of the calcium chelating agent in the solution can be correlated to a concentration on the surface of the particles. Similar binding assays can be performed using chelating agents for aluminates and other constituents of a pozzolan and/or cement. In some embodiments, two or more chelating agents to two or more different constituents can be used separately or simultaneously to provide higher resolution of selective binding.

In one embodiment, the invention relates to achieving a desired concentration of calcium oxide in a pozzolan fraction of a blended cement. In this embodiment, a first source of pozzolan is provided that varies over time in its calcium oxide content. The variation in the calcium oxide content can be in a range from about 1% to 50% by volume (or 5%-40%). The calcium content can be measured using an online chemical analyzer such as a XRD analyzer. In one embodiment, the effective calcium oxide is measured. The effective calcium oxide content can be measured directly by approximating the surface area of the pozzolan and the vol % of calcium oxide.

In this embodiment the pozzolan fraction can be made with a relatively constant calcium concentration by blending a second source of pozzolan having a different calcium concentration. The second source of pozzolan may have a calcium content that is relatively constant or may vary over time. If the second source of pozzolan varies over time, it may be desirable to measure the calcium concentration of the second source of pozzolan using an online chemical analyzer such as an XRD analyzer.

The pozzolan fraction is made to have a relatively constant calcium content by blending the first and second pozzolan streams in ratios that produce a combined pozzolan fraction that varies in calcium (or the effective calcium) less than one or both of the first and second pozzolan streams. To illustrate a hypothetical example, a first pozzolan source may have an effective calcium oxide content of 40% that varies periodically to 25%. A second pozzolan source having an effective calcium oxide content of 10% can be blended with the first pozzolan at a ratio 50:50 when the first pozzolan source is at 40% and then blended at a ratio of 100:0 when the calcium oxide is at 25%. In this manner, the effective calcium oxide content can remain 25% by vol over time. Those skilled in the art will recognize that the two different pozzolan sources can be mixed in ratios from 100% of the first pozzolan source to 100% of the second pozzolan source to achieve any desired calcium oxide content between the first pozzolan source and the second pozzolan source.

The first and second pozzolan sources can be of the same type or different types of pozzolans. In one embodiment, the first pozzolan is a class C fly and the second pozzolan source may be a Class F fly ash. In alternative embodiments, the first and second pozzolan sources may be both class F or both class C. In one embodiment, the two different pozzolan sources are from the same hydrocarbon power plant and the first pozzolan source and the second pozzolan source are collected during different conditions of operations (e.g., differences in ambient temperature, burner temperature, feed material, load, or any other factor that may affect effective calcium oxide content).

In yet another embodiment, the pozzolan fraction may be a blend of three or more pozzolan sources. A blend of three or more different pozzolan sources can also be used to reduce variation in chemical composition other than calcium. For example, a third or additional pozzolan source may be used to reduce variation in mineral contents such as silicates, magnesium, sulfates, iron and the like. A third pozzolan source may also be used to reduce the variation in carbon content.

The calcium content or effective calcium content can also be modified to produce a pozzolan fraction and/or blended cement with a relatively constant calcium content and/or reactivity by taking a series of measurements of the calcium content of the variable pozzolan stream and modifying the stream by adding a hydration stabilizer to reduce the potency of the calcium during initial hydration and/or setting. The hydration stabilizer is preferably a calcium chelating agent. The amount of hydration stabilizer added can be selected to chelate the desired quantity of calcium through the highest heat of hydration of the hydrating cement. Suitable amounts include 1-10 oz of hydration stabilizer per hundred lbs of hydraulic cement. The hydration stabilizer can be added to the pozzolan fraction or to the blended cement.

In yet another embodiment, a pozzolan fraction and/or blended cement having a relatively constant calcium content and/or reactivity can be produced by taking a series of measurements of the calcium content of a hydrocarbon feed material (e.g., coal) that is to be burned (e.g., in a coal fired power plant). The feed material is mixed with a calcium producing material (e.g., limestone) to produce a modified feed material. The calcium producing material is blended with the feed material in proportions that will produce a desired calcium content in the ash resulting from burning the modified feed material. In one embodiment, the calcium content of the ash resulting from burning the modified feed is greater than 5%, greater than 15%, greater than 25%, greater than 35%, or even greater than 45%. In one embodiment, the resulting ash can be a class C fly ash. The ash can have a relatively constant calcium content. In one embodiment, the ash resulting from burning the modified ash varies over time less than the calcium in the feed material.

In one embodiment, the difference in variation of the calcium content, effective calcium content, and/or calcium reactivity of a modified pozzolan fraction and/or a blended cement produced using any of the methods described herein is less by at least 1% in over a period of 1 month, more preferably over a period of 1 week, and most preferably over a period of 1 day. More preferably the difference in variation of the calcium content and/or effective calcium content, and/or chemical reactivity of the calcium is less by at least 2%, 3%, 4%, or 5% over a period of 1 month, 1 week, or 1 day as compared to not chemically modifying the pozzolan fraction and/or blended cement. The decrease in variation can also be measured according to the maximum variation in the pozzolan fraction or blended cement. In one embodiment, the maximum variation in the calcium content or effective calcium content, and/or in a one month period (more preferably a one week period, or even a one day period) is less than 10%, 5%, 4%, 3%, 2%, or 1% by volume, weight, or unit of reactivity.

Modifying the calcium content of a pozzolan fraction by blending two or more different pozzolan sources and/or controlling the calcium content produced in burning a hydrocarbon feed can be important to provide calcium at later stages of cement hydration. Since pozzolan particles hydrate over time, there may be some calcium in the interior of the pozzolan particle that does not hydrate in the first few days of curing but are released as hydration penetrates deeper into the particle. This allows more calcium to be released at latter stages of hydration and can provide better ultimate strength than releasing all of the calcium upon initial wetting of the particles. However, if desired, the use of lime or other sources of base can be used in combination with calcium optimization through blending different pozzolan sources.

The foregoing invention related to controlling variation of the calcium oxide content of one or more pozzolan sources can alternatively be carried out in a similar manner to control the effective aluminate content. That is, the aluminate content may be controlled by blending two or more different pozzolan sources having different effective aluminate contents to achieve a desired aluminate content and/or effective aluminate content and/or reactivity of aluminate. In one embodiment, variation in aluminate can be offset by adding sulfate (e.g., gypsum). The blending of one or more different pozzolans to achieve a desired aluminate content and/or effective aluminate content can be carried out so as to achieve a desired reduction in variability of the pozzolan fraction and/or the blended cement. The foregoing numerical values for the reduction in variability of calcium content can also be achieved for the reduction in variability of the aluminate content, effective aluminate content, and/or reactivity of aluminates in the pozzolan fraction and/or blended cement.

Other chemical constituents that vary over time in pozzolan sources can also be adjusted using the methods described herein. For example, the variation may be content or effective content of sulfate, silicate, and/or carbon. In some embodiments, the undesired variation in the initial pozzolan may be a ratio of two or more chemical constituents. For example the undesired variation over time may be a variation in the ratio of aluminate to silicate, aluminate to tricalicum silicate, aluminate to gypsum, silicate to carbon, calcium to tricalcium and/or dicalcium silicate, and similar chemical relationships that can effect strength development and set times of a concrete composition incorporating the pozzolan fraction and/or blended cement.

In one embodiment, the undesired variation in a chemical characteristic (e.g., calcium content and/or aluminate content and/or sulfate) of an initial pozzolan stream and/or modified pozzolan stream, and/or blended cement is measured using a chemical analyzer as described above with respect to FIG. 2.

As discussed, in some embodiments a modifying chemical reagent such as gypsum or hydration stabilizer may be added the pozzolan fraction and/or blended cement to mitigate undesired variability. These additions can be made by adding the chemical in-line to a stream of the pozzolan fraction and/or blended cement. The chemical reagent can be metered in at the desired concentration based on the measured variation and based on the volume of material in the pozzolan or blended cement stream. In an alternative embodiment, a modifying chemical agent can be added in batch. For a batch addition, the amount of modifying chemical to be added is based on a plurality of measurement for portions of the pozzolan stream and/or blended cement stream that are collected as a batch. The amount of modifying chemical agent will depend on the amount of variation in the various subfractions analyzed and batched.

The methods for mitigating undesired chemical variation can also be carried out by blending two or more different types of cements to obtain a desired chemical composition in a blended cement that has less variation over time as discussed above with regard to blending two or more different pozzolans.

In a preferred embodiment, the amounts and ratios of the different pozzolans, different cements, and/or chemical agents to be added or combined are controlled in part using a computer module running computer executable instructions as described above with respect to FIG. 2. The computer module receives a series of measurements from the chemical analyzer and detects variation in the pozzolan fraction and/or blended cement by comparing the readings to a concentration parameter. The concentration parameter can be a fixed numerical value for a particular chemical constituent (e.g., CaO, sulfate, aluminate, tricalcium silicate, or the like). The computer module can then calculate the ratios and/or amounts of pozzolan, cement, and/or chemical agents to be mixed to achieve a desired concentration, desired effective concentration, and/or desired chemical reactivity based on the deviation of an actual measurement from the concentration parameter.

The control module can manipulate the pozzolan fraction and/or blended cement upstream from the chemical analyzer and/or downstream from the chemical analyzer. If the control module modifies the pozzolan fraction and/or blended cement upstream from the chemical analyzer, the control module can continue making an adjustment until the actual chemical reading by the analyzers shows that the chemical composition is within a desired range of the concentration parameter. Alternatively or in addition, the modification can occur downstream from the control module.

The control module can be configured to operate conveyors, injectors, fans, feed hoppers, comminution equipment, blenders, and the like to achieve the desired modification in the content, effective content, and/or chemical reactivity of a chemical constituent of the pozzolan fraction and/or blended cement, thereby reducing the chemical variability thereof.

While carbon is generally not desirable to add to a cement mix, in some embodiments, carbon can be added to reduce variability in the carbon content of a pozzolan fraction and/or cement fraction. Other methods of reducing the variability of carbon content over time include adding surfactants and or carbon sequestering agents. In a preferred embodiment, the present invention is directed at controlling the variation of one or more chemical constituent with the proviso that the chemical constituent is not carbon.

### VII. CEMENTITIOUS COMPOSITIONS

The inventive pozzolan cement compositions can be used to make concrete, mortar, grout, molding compositions, or other cementitious compositions. In general, “concrete” refers to cementitious compositions that include a hydraulic cement binder and aggregate, such as fine and coarse aggregates (e.g., sand and rock). “Mortar” typically includes cement, sand and lime and can be sufficiently stiff to support the weight of a brick or concrete block. “Grout” is used to fill in spaces, such as cracks or crevices in concrete structures, spaces between structural objects, and spaces between tiles. “Molding compositions” are used to manufacture molded or cast objects, such as pots, troughs, posts, fountains, ornamental stone, and the like.

Water is both a reactant and rheology modifier that permits fresh concrete, mortar or grout to flow or be molded into a desired configuration. The hydraulic cement binder reacts with water, is what binds the other solid components together, and is responsible for strength development. Cementitious compositions within the scope of the present invention will typically include hydraulic cement (e.g., Portland cement), pozzolan (e.g., fly ash), water, and aggregate (e.g., sand and/or rock). Other components that can be added include water and optional admixtures, including but not limited to accelerating agents, retarding agents, plasticizers, water reducers, water binders, and the like.

It will be appreciated that pozzolan cement compositions can be manufactured (i.e., blended) prior to incorporation into a cementitious composition or they may be prepared in situ. For example, some or all of the hydraulic cement and pozzolan can be mixed together when making a cementitious composition. In the case where supplemental lime is desired in order to increase the speed and/or extent of pozzolan hydration, at least some of the supplemental lime or other base may be added to the cementitious composition directly.

Admixtures typically used with OPC can also be used in the inventive concrete compositions of the invention. Examples of suitable admixtures include, but are not limited to, hydration stabilizers, retarders, accelerantors, and/or water reducers. Additional details regarding cementitious compositions that can be manufactured according to the invention and incorporated into the embodiments disclosed herein can be found in co-pending patent application Ser. No. 12/576,117, filed Oct. 8, 2009, which is hereby incorporated by reference in its entirety.

### VIII. EXAMPLES

The following examples, when expressed in the past tense, illustrate embodiments of the invention that have actually been prepared. Examples given in the present tense are hypothetical in nature but are nevertheless illustrative of embodiments within the scope of the invention.

Cementitious mortar compositions were prepared according to ASTM C-109 in order to test the strength of mortar cubes made therefrom. The mortar compositions were prepared according to standard procedures established by ASTM C-109, including adding the cement to the water, mixing at slow speed for 30 seconds, adding the sand over a period of 30 seconds while mixing at slow speed, stopping the mixing, scraping the walls, letting the mixture stand for 90 seconds, and then mixing at medium speed for 60 seconds.

The flow of each of the cementitious mortar compositions was tested using a standard flow table, in which a sample of mortar was placed in the middle of the table, the table was subjected to 25 raps, and the diameter of the resulting mass was measured in four directions and added together to give a composite flow value in centimeters.

Thereafter, the mortar was packed into mortar cube molds using standard procedures established by ASTM C-109, including filling the molds half-way, compacting the mortar in the molds using a packing tool, filling the molds to the tops, compacting the mortar using a packing tool, and smoothing off the surface of mortar in the molds.

The mortar cube molds were placed in a standard humidity chamber for 1 day. Thereafter, the mortar cubes were removed from the molds and submerged inside buckets filled with saturated aqueous lime solution. The cubes were thereafter tested for compressive strength using a standard compressive strength press at 3 days, 7 days and 28 days.

### Examples 1-4

Examples 1-4 illustrate the effect of particle size optimizing a 70:30 blend of Portland cement and fly ash. The Portland cement used in each of Examples 1-4 was an approximate Type II cement made by grinding Type V cement more finely. Example 1 was a particle size optimized 70:30 cement/pozzolan blend. It employed a classified Portland cement identified as “cement #11”, which was obtained by passing approximate Type II Portland cement through a Microsizer Air Classifier manufactured by Progressive Industries, located in Sylacauga, Ala. and collecting the fine fraction. Example 1 also employed classified fly ash identified as “fly ash 8z1”, which was obtained by passing Class F fly ash through an air classifier twice, first to remove most of the fines below about 10 μm and second to remove most of the fines above about 50 μm. The air classifier was model CFS 8 HDS of Netzsch-Condux Mahltechnik GmbH, located in Hanau, Germany. Examples 2 and 3 were both 70:30 control blends of Portland cement and fly ash which used unclassified Type II cement (“control cement”) and Class F fly ash (“control fly ash”). Example 4 used 100% ordinary Type II Portland cement. The particle size distributions of the Portland cement and fly ash fractions were determined at Netzsch-Condux Mahltechnik GmbH using a Cilas 1064 particle size analyzer and are set forth below in Table 1.

TABLE 1

| | Percent Passing/Cumulative Total (%) | | | |
|---|---|---|---|---|
| Particle | Cement | Control | Fly Ash | Control |
| Size (μm) | #11 | cement | 8z1 | fly ash |
| 0.04 | 0.15 | 0.13 | 0.04 | 0.10 |
| 0.10 | 0.84 | 0.81 | 0.09 | 0.51 |
| 0.50 | 5.27 | 5.79 | 0.68 | 3.40 |
| 1.00 | 12.71 | 13.44 | 1.91 | 9.27 |
| 2.00 | 21.97 | 21.21 | 3.36 | 20.74 |
| 3.00 | 28.13 | 24.99 | 3.88 | 28.59 |
| 4.00 | 35.76 | 29.24 | 4.22 | 33.79 |
| 6.00 | 54.90 | 39.23 | 4.69 | 40.87 |
| 8.00 | 73.49 | 48.47 | 4.69 | 46.27 |
| 10.00 | 87.10 | 56.15 | 4.69 | 50.78 |
| 15.00 | 99.13 | 71.34 | 10.04 | 59.32 |
| 20.00 | 100.0 | 83.16 | 24.65 | 65.58 |
| 32.00 | 100.0 | 97.50 | 66.84 | 78.82 |
| 50.00 | 100.0 | 100.0 | 95.53 | 93.78 |
| 71.00 | 100.0 | 100.0 | 100.0 | 99.40 |
| 100.0 | 100.0 | 100.0 | 100.0 | 100.0 |

The compositions used in making mortar cubes according to Examples 1-4 and also the flow and strength results are set forth below in Table 2. The weight of fly ash added to the 70:30 blends was reduced to account for its reduced density compared to the Portland cement in order to maintain 30% volumetric replacement.

TABLE 2

| Component/ | Example | | | | | | | |
|---|---|---|---|---|---|---|---|---|
| strength | 1 | | 2 | | 3 | | 4 | |
| Cement #11 | 518 | g | — | | — | | — | |
| Fly Ash 8z1 | 162.1 | g | — | | — | | — | |
| Control OPC | — | | 518 | g | 518 | g | 740 | g |
| Control FA | — | | 162.1 | g | 162.1 | g | — | |
| Graded Sand | 2035 | g | 2035 | g | 2035 | g | 2035 | g |
| Water | 360 | g | 360 | g | 330 | g | 360 | g |
| Flow | 106 | | 136+* | | 109.5 | | 118 | |
| 3-day strength | 26.6 | MPa | 16.0 | MPa | 15.8 | MPa | 28.6 | MPa |
| 7-day strength | 26.8 | MPa | 21.2 | MPa | 18.2 | MPa | 32.4 | MPa |
| 28-day strength | 40.9 | MPa | 32.0 | MPa | 35.4 | MPa | 45.6 | MPa |

*Only 21 taps on flow table

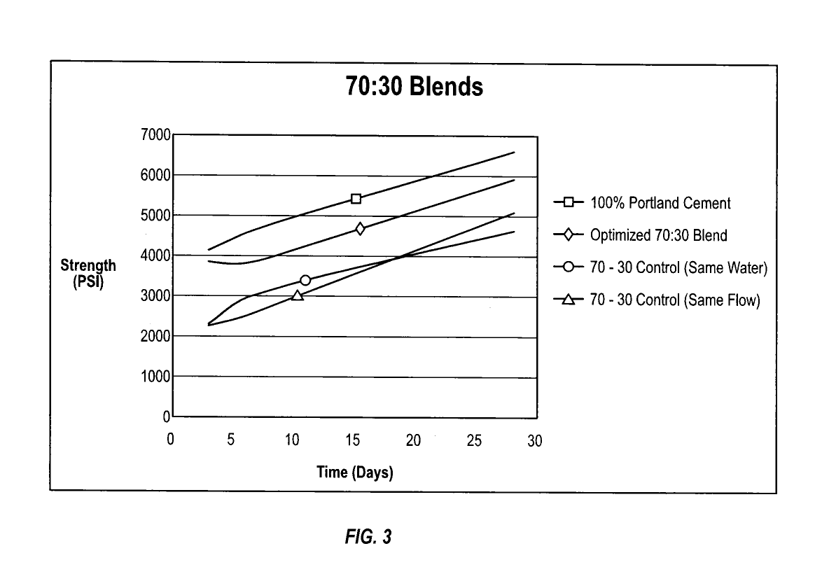

As can be seen from the data in Table 2, the inventive 70:30 blend of Example 1 had 93% of the strength of the 100% OPC composition of Example 4 at 3 days, 83% of the strength at 7 days, and 90% of the strength at 28 days. By comparison, the 70:30 control blends of Examples 2 and 3 only had 56% and 55%, respectively, of the strength of the 100% OPC composition of Example 4 at 3 days, 65% and 56%, respectively, of the strength at 7 days, and 70% and 78% of the strength at 28 days. Particle size optimizing the Portland cement and fly ash fractions yielded substantially greater strength development compared to the control blends at 3, 7 and 28 days. The increase in strength was particularly pronounced at 3 days. FIG. 3 graphically illustrates and compares the strengths obtained using the compositions of Examples 1-4.

### Examples 5-14

Other mortar compositions (i.e., 60:40 and 70:30 blends) were manufactured using cement #11 and fly ash 8z1. In addition, mortar compositions were manufactured using another classified cement material identified as “cement #13” and another classified fly ash identified as “fly ash 7G”. Cement #13 was classified at the same facility as cement #11. The particle size distributions of cement #11, cement #13 and the control cement were determined at the classifying facility using a Beckman Coulter LS 13 320 X-ray diffraction analyzer and are set forth below in Table 3.

TABLE 3

| Particle Size | Percent Passing/Cumulative Total (%) | | |
|---|---|---|---|
| (μm) | Cement #11 | Cement #13 | Control cement |
| 0.412 | 0.26 | 0.33 | 0.14 |
| 0.545 | 2.33 | 2.96 | 1.24 |
| 0.721 | 6.42 | 8.21 | 3.43 |
| 0.954 | 11.9 | 15.3 | 6.37 |
| 1.261 | 18.1 | 23.5 | 9.66 |
| 1.669 | 24.7 | 32.5 | 13.0 |
| 2.208 | 32.1 | 42.1 | 16.6 |
| 2.920 | 40.9 | 52.7 | 20.5 |
| 3.863 | 51.6 | 64.2 | 25.3 |
| 5.111 | 64.1 | 76.1 | 31.5 |
| 6.761 | 77.4 | 87.3 | 39.4 |
| 8.944 | 89.6 | 96.0 | 49.0 |
| 11.83 | 97.9 | 99.8 | 60.3 |
| 15.65 | 99.97 | 100 | 73.0 |
| 20.71 | 100 | 100 | 85.6 |
| 24.95 | 100 | 100 | 92.4 |
| 30.07 | 100 | 100 | 96.7 |
| 36.24 | 100 | 100 | 98.9 |
| 43.67 | 100 | 100 | 99.8 |
| 52.63 | 100 | 100 | 99.995 |

Fly ash 7G was classified at the same facility as fly ash 8z1 (Netzsch-Condux Mahltechnik GmbH) but was only classified once to remove fine particles. It was not classified a second time to remove coarse particles. The particle size distribution of fly ash 7G was determined using a Cilas 1064 particle size analyzer and is set forth below in Table 4. The PSD of the control fly ash is included for comparison

TABLE 4

| Particle | Percent Passing/Cumulative Total (%) | |
|---|---|---|
| Size (μm) | Fly Ash 7 G | Control fly ash |
| 0.04 | 0.00 | 0.10 |
| 0.10 | 0.00 | 0.51 |
| 0.50 | 0.51 | 3.40 |
| 1.00 | 1.34 | 9.27 |
| 2.00 | 2.24 | 20.74 |
| 3.00 | 2.60 | 28.59 |
| 4.00 | 2.80 | 33.79 |
| 6.00 | 2.99 | 40.87 |
| 8.00 | 2.99 | 46.27 |
| 10.00 | 2.99 | 50.78 |
| 15.00 | 5.26 | 59.32 |
| 20.00 | 10.94 | 65.58 |
| 32.00 | 29.26 | 78.82 |
| 50.00 | 54.79 | 93.78 |
| 71.00 | 76.18 | 99.40 |
| 100.0 | 92.01 | 100.0 |
| 150.0 | 99.46 | 100.0 |

The compositions used in making mortar cubes according to Examples 5-14 and also the flow and strength results are set forth below in Tables 5 and 6. The amount of fly ash added to some of the blends was reduced to account for its reduced density compared to the Portland cement in order to maintain a 30% or 40% volumetric replacement. In other cases, the replacement was 30% or 40% by weight. In one example, lye was added; in another, slaked lime.

TABLE 5

| Component/ | Example | | | | | | | | | |
|---|---|---|---|---|---|---|---|---|---|---|
| strength | 5 | | 6 | | 7 | | 8 | | 9 | |
| Cement #11 | 444 | g | 518 | g | 444 | g | 444 | g | 444 | g |
| Cement #13 | — | | — | | — | | — | | — | |
| Fly Ash 8z1 | — | | — | | 216.1 | g | — | | — | |
| Fly Ash 7 G | 296 | g | 222 | g | — | | 216.1 | g | — | |
| Control FA | — | | — | | — | | — | | 216.1 | g |
| Graded Sand | 2035 | g | 2035 | g | 2035 | g | 2035 | g | 2035 | g |
| Water | 390 | g | 370 | g | 360 | g | 360 | g | 360 | g |
| Flow | 109 | | 95 | | 122 | | 110 | | 107.5 | |
| 3-day | 19.1 | MPa | 26.1 | MPa | 19.4 | MPa | 16.7 | MPa | 20.7 | MPa |
| 7-day | 21.5 | MPa | 33.0 | MPa | 26.7 | MPa | 25.3 | MPa | 21.8 | MPa |
| 28-day | 28.2 | MPa | 35.5 | MPa | 28.2 | MPa | 30.3 | MPa | 25.9 | MPa |

TABLE 6

| Component/ | Example | | | | | | | | | |
|---|---|---|---|---|---|---|---|---|---|---|
| strength | 10 | | 11 | | 12 | | 13 | | 14 | |
| Cement #11 | 444 | g | — | | 518 | g | 444 | g | 444 | g |
| Cement #13 | — | | 444 | g | — | | — | | — | |
| Fly Ash 8z1 | 216.1 | g | 216.1 | g | 162 | g | — | | — | |
| Fly Ash 7 G | — | | — | | — | | 216.1 | g | 216.1 | g |
| Type S Lime | — | | — | | — | | — | | 20 | g |
| NaOH | | | | | | | 3.3 | g | — | |
| Graded Sand | 2035 | g | 2035 | g | 2035 | g | 2035 | g | 2035 | g |
| Water | 350 | g | 360 | g | 360 | g | 360 | g | 360 | g |
| Flow | 106.5 | | 110.5 | | 86.5 | | 89 | | 98 | |
| 3-day | 19.7 | MPa | 18.7 | MPa | 19.9 | MPa | 17.9 | MPa | 17.9 | MPa |
| 7-day | 20.9 | MPa | 21.9 | MPa | 25.9 | MPa | 19.1 | MPa | 17.6 | MPa |
| 28-day | 27.6 | MPa | 30.6 | MPa | 28.6 | MPa | 23.7 | MPa | 28.6 | MPa |

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for manufacturing a blended pozzolan having a characteristic in an established amount or range prior to blending with cement, comprising:
blending two or more pozzolans that differ in a characteristic selected from the group consisting of calcium oxide content, alumina content, silica content, ratio of alumina to silica, amorphous mineral content, crystalline mineral content, iron oxide content, magnesium oxide content, alkali metal content, sulfate content, particle size distribution, specific gravity, and combinations thereof to form the blended pozzolan;
measuring the characteristic of the blended pozzolan and determining whether the characteristic is in the established amount or range; and
upon determining that the characteristic of the blended pozzolan is outside the established amount or range, modifying a blending ratio of the two or more pozzolans to restore the characteristic of the blended pozzolan to the established amount or range.

2. The method of claim 1, wherein the two or more pozzolans are selected from the group consisting of coal ash, fly ash, bottom ash, municipal waste ash, biomass ash, ground granulated blast furnace slag (GGBFS), steel slag, natural pozzolan, volcanic ash, pumice, diatomaceous earth, metakaolin, silica fume, calcined clay, and trass.

3. The method of claim 1, wherein the characteristic of the blended pozzolan comprises calcium oxide content.

4. The method of claim 1, wherein the characteristic of the blended pozzolan comprises silica content.

5. The method of claim 1, wherein the characteristic of the blended pozzolan comprises alumina content.

6. The method of claim 1, wherein the characteristic of the blended pozzolan comprises iron oxide content.

7. (canceled)

8. The method of claim 1, wherein the two or more pozzolans comprise a pozzolan rich in calcium oxide and a pozzolan deficient in calcium oxide.

9. The method of claim 8, wherein the pozzolan rich in calcium oxide comprises at least 20% calcium oxide and the pozzolan deficient in calcium oxide comprises no more than 10% calcium oxide.

10. The method of claim 1, wherein the two or more pozzolans comprise a pozzolan rich in one or more of silica, alumina or iron oxide and a pozzolan deficient in the one or more of silica, alumina or iron oxide.

11. (canceled)

12. The method of claim 1, wherein at least one of the pozzolans comprises fly ash and at least one other of the pozzolans comprises natural pozzolan.

13. The method of claim 1, wherein the two or more pozzolans comprise a metallurgical slag and at least one of an ash or natural pozzolan.

14-15. (canceled)

16. The method of claim 1, further comprising blending a nonpozzolanic component with the two or more pozzolans.

17. The method of claim 16, wherein the nonpozzolanic component comprises limestone.

18. The method of claim 16, wherein the nonpozzolanic component comprises Portland cement.

19. The method of claim 16, wherein the nonpozzolanic component comprises calcium oxide and/or calcium hydroxide.

20. (canceled)

21. The method of claim 1, wherein the characteristic is measured by an X-ray diffraction device or an X-ray fluorescence device.

22-29. (canceled)

30. A method for blending different pozzolans together to form a blended pozzolan having at least one chemical characteristic of class F fly ash or class C fly ash, comprising:
establishing at least one chemical characteristic of class F fly ash or class C fly ash selected from the group consisting of calcium oxide content, alumina content, silica content, ratio of alumina to silica, amorphous mineral content, crystalline mineral content, iron oxide content, magnesium oxide content, and alkali metal content
providing a first pozzolan that is lacking in the at least one chemical characteristic of class F fly ash or class C fly ash, wherein the first pozzolan comprises fly ash;
providing a second pozzolan that differs from the first pozzolan with respect to the at least one chemical characteristic of class F fly ash or class C fly ash;
establishing a blending protocol of the first pozzolan and the second pozzolan in order to form the blended pozzolan having the at least one chemical characteristic of class F fly ash or class C fly ash; and
blending the first pozzolan with the second pozzolan according to the blending protocol to produce the blended pozzolan having the at least one chemical characteristic of class F fly ash or class C fly ash.

31. A method as in claim 30, wherein the at least one chemical characteristic comprises calcium oxide content.

32-33. (canceled)

34. A method of manufacturing a blended pozzolan having a calcium oxide content characteristic of class F fly ash or class C fly ash prior to blending with cement, comprising:
blending two or more pozzolans that differ in calcium oxide content to form the blended pozzolan;
measuring the calcium oxide content of the blended pozzolan and determining whether the calcium oxide content is in the established amount or range; and
upon determining that the calcium oxide content of the blended pozzolan is outside the established amount or range, modifying a blending ratio of the two or more pozzolans to restore the calcium oxide content of the blended pozzolan to the established amount or range.

35. A method as in claim 35, wherein at least one of the two or more pozzolans comprises fly ash and at least one other of the two or more pozzolans comprises natural pozzolan.
